(19) United States
(12) Patent Application Publication
(10) Pub. No.: US 2011/0245130 A1
(43) Pub. Date: Oct. 6, 2011

(54) POLYMER COMPOSITION AND PROCESS FOR THE PRODUCTION THEREOF

(76) Inventors: Jeffrey Scott Dupont, Cincinnati, OH (US); Atsuro Yoneda, Osaka (JP); Daisuke Michitaka, Osaka (JP)

(21) Appl. No.: 13/061,527

(22) PCT Filed: Sep. 1, 2009
(86) PCT No.: PCT/JP2009/065553

§ 371 Date: Jun. 22, 2011

(30) Foreign Application Priority Data
Sep. 1, 2008 (JP) 2008-223692

(51) Int. Cl. C11D 3/60; C11D 17/00

(52) U.S. Cl. 510/351; 510/445; 510/475; 510/360

(57) ABSTRACT

[Objective] The objective is to provide a polymer composition having an improved lime soap dispersibility from the prior art in the case of detergent applications and process for the production of it.

[Solution] A laundry detergent or cleaning composition, which comprises a polymer composition obtainable by carrying out polymerization reaction of a polyoxyalkylene compound and an acid group-containing unsaturated monomer in the presence of a polymerization initiator, the polyoxyalkylene compound having at least one of aryl group with 8 or more carbon atoms, alkyl group having 8 or more carbon atoms and alkenyl group of 8 or more carbon atoms and oxyalkylene group, a content of an oxyalkylene-origin structure per mol of the polyoxyalkylene compound being in the range of 10-100 mol; a ratio by weight of a polyoxyalkylene compound-origin structure to the acid group-containing unsaturated monomer-origin structure being in the range of 80:20 to 50:50 (provided 80:20 not included), and the composition containing 0.3-20 parts by weight of at least one compound selected from the following compounds 1-3 per 100 parts by weight of the acid group-containing unsaturated monomer. 1-3 per 100 parts by weight of acid group-containing unsaturated monomer.

### TECHNICAL FIELD

This invention pertains to a polymer composition and process for the production of it.

### BACKGROUND ART

Previously, detergents used for washing of clothes, etc., were being compounded with detergent builders (detergent aids) such as zeolite, carboxymethylcellulose, polyethylene glycol, etc., for the purpose of improving the washing effects of detergents.

Furthermore, in addition to various detergent builders described above, detergent compositions have been being compounded with polymers as a detergent builder.

For example, the use as a detergent builder has been disclosed for a water-soluble/water-dispersible graft polymer having a constant amount of a grafted component and hydrophobic residual group, which is bonded to the graft component through a polyglycol ether chain of a prescribed chain length (refer to Patent Reference 1 and 2).

In recent years the concerns on environmental problems have been increased by consumers, and many consumers have adopted a new trend in saving water by carrying out washing with used water previously used in a Japanese-style bath tub. As a result, the performance required for detergent builders has been being changed.

Specifically, this used water contains soap components used for cleaning face and bodies. The soap components form so-called lime soap as a result of bonding with calcium contained in tap water, etc., and as a result of this substance adhering to fibers of clothing washed, it is liable to become a cause of yellowing of fibers or generation of unpleasant odor. Furthermore, the deposition of this lime soap inside a washing machine is a cause of problems related to plumbing such as clogging, etc.

Various lime soap dispersants have been proposed previously showing improvements to some extent, but there has been no completely satisfactory result obtained yet (Patent Reference 3-6).

A graft polymer prepared by carrying out graft polymerization of a polyoxyalkylene compound with an acid group-containing unsaturated monomer has been used previously. For example, Patent Reference 7 discloses a graft copolymer, which is suitable for polyurethane resin manufacturing and can be prepared by carrying out graft polymerization in the presence of a special azo-type radical polymerization initiator. Furthermore, as a graft polymer known for applications as a sizing agent dispersant used for prevention of ink blotting or smearing in paper, a water-soluble graft polymer prepared by carrying out graft polymerization of a polyalkylene compound with a monoethylenically unsaturated monomer component containing a monoethylenically unsaturated carboxylic acid monomer has also been known (refer to Patent Reference 8).

### CITATION LIST

### Patent Literature

[PTL 1] Japanese Patent Publication (Kokai) No. Sho 59 (1984)-62614
[PTL 2] Japanese Patent Publication (Kokai) No. 2007-254679
[PTL 3] Japanese Patent Publication (Kokai) No. Hei 11 (1999)-511780
[PTL 4] Japanese Patent Publication (Kokai) No. 2002-201498
[PTL 5] Japanese Patent Publication (Kokai) No. 2002-201498
[PTL 6] Japanese Patent Publication (Kokai) No. Hei 1 (1989)-185398
[PTL 7] Japanese Patent Publication (Kokai) No. Sho 50 (1975)45894
[PTL 8] Japanese Patent Publication (Kokai) No. Hei 11 (1999)-279984

### SUMMARY OF THE INVENTION

### Technical Problem

In spite of various graft polymers reported previously, the development of a detergent builders suitable for the present consumer needs as described above has been strongly desirable.

Therefore, the objective of this invention is to provide a polymer composition having an improved ability for dispersion of lime soap in the case of detergent applications and process for the production of it.

### Solution Problem

The inventors of this invention studied diligently to accomplish the above objective. As a result, they found that if the polymerization of a polyoxyalkylene compound and acid group-containing monomer in a specific proportion was carried out with a special catalyst, the polymer composition prepared showed an improved lime soap dispersion ability, and they arrived at the present invention.

Specifically, this invention is a polymer composition characterized by being a polymer composition obtainable by carrying out polymerization reaction of a polyoxyalkylene compound and an acid group-containing unsaturated monomer in the presence of a polymerization initiator, the polyoxyalkylene compound having at least one of aryl group with 8 or more carbon atoms, alkyl group having 8 or more carbon atoms and alkenyl group of 8 or more carbon atoms and oxyalkylene group, a content of an oxyalkylene-origin structure per mol of the polyoxyalkylene compound being in the range of 10-100 mol; a ratio by weight of polyoxyalkylene compound-origin structure to the acid group-containing unsaturated monomer-origin structure being in the range of 80:20 to 50:50 (provided 80:20 not included), and the composition containing 0.3-20 parts by weight of at least one compound selected from the following compounds 1-3 per 100 parts by weight of the acid group-containing unsaturated monomer.

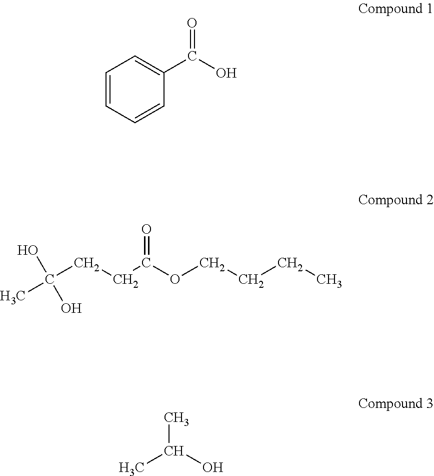

### Advantageous Effects of Invention

The polymer composition of this invention shows an excellent ability for dispersion of lime soap. Therefore, if the polymer composition of this invention is used as a detergent builder, it is possible to inhibit any adsorption of lime soap on fibers at the time of washing. Therefore, the polymer composition of this invention is suitably usable as a detergent additive.

### BRIEF EXPLANATION OF DRAWING

FIG. 1 It is a drawing showing the results of evaluation of any effect on the grafting rate when the graft polymerization of polyoxyalkylene compound with a relatively small amount of acrylic acid was carried out with various kinds of polymerization initiators.

### DESCRIPTION OF EMBODIMENTS

This invention is explained in detail as follows.

The polymer composition of this invention is a polymer composition prepared by carrying out the polymerization reaction of a polyoxyalkylene compound and acid group-containing unsaturated monomer in a specific proportion in the presence of a special polymerization initiator.

### [Polyoxyalkylene Compound]

The polyoxyalkylene compound of this invention has at least one hydrophobic group selectable from aryl group with 8 or more carbon atoms, alkyl group having 8 or more carbon atoms and alkenyl group of 8 or more carbon atoms and furthermore, oxyalkylene group. The content of the oxyalkylene-origin structure (number of mole of oxyalkylene group added) per mol of the polyoxyalkylene compound is in the range of 10-100 mol.

Although it is not especially restricted, specific examples of the polyoxyalkylene compound of this invention have a structure represented by the following formula (1).

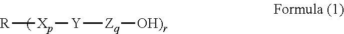

In the above formula (1), R is an aryl group with 8 or more carbon atoms, alkyl group having 8 or more carbon atoms or alkenyl group of 8 or more carbon atoms. The alkyl or alkenyl group may be a straight or branched chain group. In this case, the number of carbon atoms for R is desirably in the range of 8-20, especially 10-20, preferably 11-18 and optimally 12-14. If the number of carbon atoms for R is below the lower limit, the interaction between the polymer prepared and lime soap is liable to become weak, and there is a tendency of reduced dispersion. On the other hand, if the number of carbon atoms for R is below 20, the viscosity is proper, and the polymerization reaction can be carried out easily.

If the number of carbon atoms in R is within the above range, the ability of the polymer composition dispersing lime soap is improved.

The graft polymer preferably contains no aromatic ring in the structure. If the graft polymer of this invention is discharged into the environment, and the polymer is decomposed, any aromatic ring contained inside the polymer can become an environmentally hazardous substance. From this view point, R is preferably a hydrogen atom, alkyl or alkenyl group. Furthermore, from the viewpoint of relatively low viscosity and easy handling, R is preferably a secondary alkyl or alkenyl group.

As an alkyl group having 8 or more carbon atoms, there are, for example, 2-ethylhexyl, octyl, nonyl, decyl, undecyl, dodecyl, tridecyl, tetradecyl, pentadecyl, hexadecyl, heptadecyl, octaadecyl, nonadecyl, icocyl, etc.

Furthermore, as an alkenyl group having 8 or more carbon atoms, there are, for example, octylene, nonylene, decylene, undecylene, dodecylene, tridecylene, tetradecylene, pentadecylene, hexadecylene, heptadecylene, octadecylene, nonadecylene, icocylene, etc. R is preferably 2-ethylhexayl, dodecyl, tridecyl, tetradecyl, dodecylene, tridecylene or tetradecylene among them, and it is optimally 2-ethylehexyl, dodecyl, tridecyl or tetradecyl.

As an aryl group having 8 or more carbon atoms, there are, for example, phenethyl, 2,3- or 2,4-xylyl, mesityl, naphthyl, anthryl, phenanthryl, biphenylyl, trityl, pyrenyl, etc. The use of phenethyl, 2,3- or 2,4-xylyl or naphthyl group is preferable, and optimally, it is a phenethyl, 2,3- or 2,4-xylyl group.

In the above formula (1), X is;

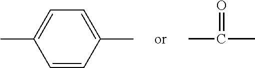

and p is 0-1. Incidentally, as described above, the graft polymer of this invention preferably contains no aromatic ring in its structure. Therefore, if p is 1 in the above formula (1), X is preferably a carbonyl group. However, p is preferably 0 (that is, no X is present).

In the above formula (1), Y is represented by one of the following formulas.

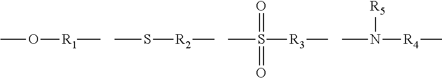

In the above formulas, R₁-R₄ are independently and respectively alkylene groups having 2-6 carbon atoms, especially 2-4 carbon atoms, preferably 2-3 carbon atoms and optimally 2 carbon atoms. Furthermore, R₅ is a hydrogen atom or group represented by the following formula (2).

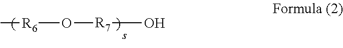

In the formula (2) R₆ and R₇ are independently and respectively alkylene groups having 2-6 carbon atoms, especially 2-4 carbon atoms, preferably 2-3 carbon atoms and optimally 2 carbon atoms. Furthermore, s is in the range of 0-200, especially 0-100, preferably 0-70 and optimally 0-55. Incidentally, if the value of s is 2 or higher, there may be a single kind of R₇ or mixture of several kinds. From the viewpoint of precipitation inhibitory ability improvement, Y is preferably —O—R₁—.

In the above formula (1) Z is an oxyalkylene group. In this case, the number of carbon atoms of Z is generally in the range of 2-20, especially 2-15, furthermore, 2-10, preferably 2-5 and optimally 2-3, but 2 is most preferable. As a specific example of this oxyalkylene group, there are, for example, groups originated from compounds such as ethylene oxide (EO), propylene oxide (PO), isobutylene oxide, 1-butene oxide, 2-butene oxide, trimethylethylene oxide, tetramethylene oxide, tetramethylethylene oxide, butadiene monoxide, octylene oxide, styrene oxide, 1,1-diphenylethylene oxide, etc. Z is preferably an EO- or PO-origin group (that is, oxyethylene or oxypropylene group), and optimally, it is an oxyethylene group. Incidentally, there may be only a single kind of Z or 2 or more kinds present in a mixed state. In the formula (1), q is generally in the range of 9-99, especially 9-79, preferably, 14-64 and optimally 19-59. If q is below 9, there is a risk of the polymerization reaction becoming difficult to be carried out. Furthermore, the water-solubility of the polymer is reduced, and consequently, there is a risk of the ability dispersing lime soap being reduced. On the other hand if q is over 99, the viscosity is liable to become too high to carry out the polymerization reaction, or even if the polymerization reaction can be carried out, the use of the polymer prepared as a detergent builder is liable to become difficult. Incidentally, the larger the value for q, the more the improvement in the yield of the graft polymer.

The group formed with the oxyalkylene group [that is Zq in the above formula (1)] is preferably a group containing an oxyethylene group (—O—CH₂—CH₂—) as a main component. In this case, the phrase “oxyethylene group as a main component” means that if there are 2 or more kinds of oxyalkylene groups present in the monomer, the oxyethylene group is to share most of the total number of the oxyalkylene groups present in the system. As a result, the polymerization reaction during the production process is carried out smoothly providing excellent effects improving water solubility and ability to disperse lime soap.

If the phrase “oxyethylene group as a main component” in Zq in the formula (1) is to be represented by mol % of the oxyethylene group in 100 mol % of the total oxyalkylene groups, it is preferably in the range of 50-100 mol %. If the content of the oxyethylene group is below 50 mol %, there is a trend of the hydrophilic property of the group formed with the oxyalkylene group being reduced. The content is desirably 60 mol % or higher, especially 70 mol % or higher, preferably 80 mol % or higher and optimally 90 mol % or higher,

In the above formula (1), r is an integer of 1-6. If the value of r is 2 or larger, the polyoxyalkylene compound represented by the above formula (1) has a structure of these 2 or more units of the group inside the parenthesis of the above formula (1) being respectively bonded to different carbon atoms of R (specific alkyl or alkylene group) explained above and does not include a repeated structure of the group inside the parenthesis of the above formula (1) as a repeating unit. In this case, the multiple units of the group inside the parenthesis of the above formula (1) may be identical or different. Incidentally, the value of r is generally in the range of 1-4, preferably 1-2 and optimally, it is 1.

Among those compound represented by the formula (1), those polyoxyethylene compounds optimally usable in this invention are represented by the following formula (3).

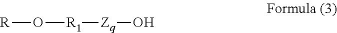

In the above formula (3), R, R₁, Z and q are same as those in the formula (1). Specifically, they are identical to those explained in the paragraphs for the above formula (1).

These polyoxyalkylene compounds may be acquired by purchasing if they are commercially available or they can be synthesized. As a method to synthesize such polyoxyalkylene compounds in the latter case, there are, for example, methods to use 1) anionic polymerization to use a base catalyst, for example, strong alkaline compounds such as alkali metal hydroxide, alkoxide, etc., alkyl amine, etc.; 2) cationic polymerization to use a catalyst such as halide of metal or semimetal, mineral acid, acetic acid, etc.; or 3) coordination polymerization to use metal alkoxide of aluminum, iron, zinc, etc., alkaline earth metal compound, Lewis acid, etc., to add an alkylene oxide compound selectable from those described above to an alcohol, ester, amine, amide, thiol, sulfonic acid, etc., containing the hydrocarbon portion of the polyoxyalkylene compound. Furthermore, as a polyoxyalkylene compound, there are, for example, polyethylene glycol, methoxypolyethylene glycol, butoxypolyethylene glycol and phenoxypolyethylene glycol.

### [Acid Group-Containing Unsaturated Monomer]

In the polymer of this invention with the polyoxyalkylene compound and acid group-containing unsaturated monomer graft-polymerized (simply called “graft polymer”, below), the aid group-containing unsaturated monomer forms a grafted chain on the carbon atom of the polyoxyalkylene chain of the polyoxyalkylene compound described above as a result of graft polymerization.

The acid group-containing unsaturated monomer is a monomer having an acid group. As an acid group in this case, there are, for example, carboxyl, sulfonic, phosphonic, etc. As a specific example of such an acid group-containing unsaturated monomer, there are, for example, carboxyl group-containing monomers such as (meth)acrylic acid, maleic acid, fumaric acid, itaconic acid, crotonic acid, etc.; sulfonic group-containing monomers such as 2-acrylamide-2-memthylpropanesulfonic acid, (meth)acrylsulfonic acid, vinylsulfonic acid, 2-hydroxy-3-allyloxy-1-propanesulfonic acid, 2-hydroxyl-3-butenesulfonic acid, etc.; and phosphonic group-containing monomers such as vinylphosphonic acid, (meth)allylphosphonic acid, etc. From the viewpoint of high polymerizability and weak acidity for easy handling, the use of those carboxyl group-containing monomers such as (meth)acrylic acid, maleic acid, etc., among them is preferable, especially, the use of acrylic aid and maleic acid is preferable, and the use of acrylic acid is optimal. These acid group-containing unsaturated monomers may be used alone or as a mixture of 2 or more kinds for concomitant applications.

Incidentally, in addition to those acid group-containing unsaturated monomers, other monomers copolymerizable with the specific acid group-containing unsaturated monomer used may also be included. These other monomers are not especially restricted, but there are, for example, hydroxyl group-containing alkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, α-hydroxymethylethyl (meth)acrylate, etc.; alkyl (meth)acrylates prepared by esterification of (meth)acrylic acid with alcohols having 1-18 carbon atoms such as methyl (meth)acrylate, ethyl (meth)acrylate, butyl(meth)acrylate, cyclohexyl (meth)acrylate, etc.; amino group-containing (meth)acrylates such as dimethylaminoethyl (meth)acrylate, its quarternary derivative, etc.; amide group-containing monomers such as (meth)acrylamide, dimethylacrylamide, isopropylacrylamide, etc.; vinyl esters such as vinyl acetate, etc.; alkenes such as ethylene, propylene, etc.; aromatic vinyl monomers such as styrene, styrenesulfonic acid, etc.; maleimide derivatives such as maleimide, phenyl maleimide, cyclohexyl maleimide, etc.; nitrile group-containing vinyl monomers such as (meth)acrylonitrile, etc.; aldehyde group-containing vinyl monomers such as (meth)acrolein, etc.; alkyl vinyl ethers such as methyl vinyl ether, ethyl vinyl ether, butyl vinyl ether, etc.; and other functional group-containing monomers such as vinyl chloride, vinylidene chloride, allyl alcohol, vinyl pyrrolidone, etc. These other monomers may be used alone or concomitantly as a mixture of 2 or more kinds. Furthermore, if other monomers are contained in addition to the acid group-containing unsaturated monomer as a monomer component, the addition structures of those structural units of respective monomer origins in the grafted chains are not especially restricted, and for example, it may be a random addition or block addition. The acid group-containing unsaturated monomers and other monomers copolymerizable with the acid group-containing unsaturated monomers are also called “monomer components”, below.

The proportion of the acid group-containing unsaturated monomers in all of the acid group-containing unsaturated monomers and other monomers copolymerizable with the acid group-containing unsaturated monomers is not especially restricted, but from the viewpoint of allowing the effect of this invention to be exhibited sufficiently, the proportion of the acid group-containing unsaturated monomers on the total amount of the monomer components is generally in he range of 80-100 mol %, especially 90-100 mol %, preferably 95-100 mol % and optimally, it is 100 mol %.

### [Graft Polymer]

As described above, the graft polymer of this invention has a structure of a polyoxyalkylene compound with an acid group-containing unsaturated monomer graft-polymerized.

The weight average molecular weight of the graft polymer of this invention is suitably determined considering the desired performance as a detergent builder, etc, and thus, it is not especially restricted, but specifically, the weight average molecular weight of the graft polymer of this invention is generally in the range of 300-50,000, preferably 500-30,000 and optimally 1000-20,000. If this weight average molecular weight is too large, the viscosity is liable to become so high that the handling is liable to become difficult. On the other hand, if this weight average molecular weight is too small, there is a risk of the ability dispersing lime soap not being exhibited. Incidentally, the weight average molecular weight of the graft polymer of this invention in this specification is defined as the value determined with the measurement method explained in the application examples described later.

The amount of an acid group-containing unsaturated monomer to be grafted is not especially restricted, and it is suitably determined considering the desired properties as a detergent builder, ease of manufacturing, etc. The amount of acid group-containing unsaturated monomers contained in the monomer components may be controlled.

### [Polymer Composition]

The polymer composition of this invention is essentially required to contain the graft polymer. In addition, it may contain polyoxyalkylene compound not consumed in the reaction, by-products of the acid group-containing unsaturated monomer origin, polymerization initiator not consumed in the reaction, polymerization initiator decomposition products, polymer of the acid group-containing unsaturated monomer, etc.

The proportion of polyoxyalkylene compound-origin structure to acid group-containing unsaturated monomer-origin structure in the polymer composition of this invention is as a ratio by weight of polyoxyalkylene compound-origin structure to acid group-containing unsaturated monomer-origin structure, generally in the range of 80:20 to 50:50, especially 78:22 to 50:50, furthermore, 77:23 to 55:45, preferably 76:24 to 60:40 and optimally 75:25 to 65:35. If the amount of the acid group-containing unsaturated monomer-origin structure is too low, there is a risk of the ability dispersing lime soap being reduced. On the other hand, if the content of the acid group-containing unsaturated monomer-origin structure is too high, there is a tendency of an improved yield for the graft polymer, but also a tendency of the ability dispersing lime soap being reduced, and thus, the content is desirably below the upper limit in the range described above.

Incidentally, when the weight ratio of polyoxyalkylene compound-origin structure to acid group-containing unsaturated monomer-origin structure is to be calculated, the weight of the structure of the acid group-containing unsaturated monomer is that of the corresponding acid-type derivative.

Incidentally, the polyoxyalkylene compound-origin structure is the total of the polyoxyalkylene compound-origin structure in the graft polymer prepared and polyoxyalkylene compound not consumed in the reaction (including any homopolymer of the polyoxyalkylene compound). Therefore, the mass of the polyoxyalkylene compound-origin structure is same as the mass of the polyoxyalkylene compound used as the time of graft polymerization. Similarly, the acid group-containing unsaturated monomer-origin structure is the total of the acid group-containing unsaturated monomer-origin structure in the graft polymer, acid group-containing unsaturated monomer not consumed in the reaction and homopolymer of the acid group-containing unsaturated monomer formed. Therefore, the mass of the acid group-containing unsaturated monomer-origin structure is same as the mass of the acid group-containing unsaturated monomer used at the time of graft polymerization.

In this invention, a specific kind of polymerization initiator described later is used to reduce the amount of the polyoxyalkylene compound not consumed in the reaction. Specifically, for 100 parts by weight of the polyoxyalkylene compound consumed and unconsumed in the reaction (that is, 100 parts by weight of the polyoxyalkylene compound added to the reaction system), the amount of the polyoxyalkylene compound consumed in the reaction is generally in the range of 45-100 parts by weight, preferably 50-100 parts by weight and optimally 55-100 parts by weight. Incidentally, the amount of the polyoxyalkylene compound consumed in the reaction is calculated from the amount of the polyoxyalkylene compound not consumed into reaction described in the application examples shown later.

Incidentally, the polymer composition in this application is not especially restricted, but from the viewpoint of production efficiency, it is a composition, which can be prepared without any purification state of impurity removal, etc. In the polymer composition of this invention, the amount of the residual polyoxyalkylene compound is reduced, and the yield of the graft polymer (grafted product) is improved, and thus, if it were used in detergents, the effect of improving ability to disperse lime soap would be effectively exhibited. In addition, the polymer composition of this invention also includes those diluted products obtained by dilution (1-400 wt % dilution on the amount of the mixture) of the reaction mixture after the polymerization stage with a small amount of water for handling convenience.

The word “composition” in this application is used with a meaning as a mixture of the graft polymer as the essential component containing 1, 2 or more kinds of the compounds 1-3 described later in addition to the graft copolymer.

The yield of the graft polymer is the value calculated with the graft polymer yield computation method described later. Incidentally, the higher the composition ratio of a monomer, the higher the possibility of a homopolymer of that monomer being formed and thus, the lower the graft polymer yield, in general. Furthermore, there is also a tendency of increased homopolymer formation from a monomer eve if the composition ratio of the monomer is increased beyond a certain composition, and consequently, the reduction in the residual amount of the polyoxyalkylene compound not consumed is generally leveled off. However, it is possible to achieve a high graft yield even the composition ratio of the monomer is increase by using, for example a special initiator described later.

The polymer composition of this application may be allowed to contain at least one of the following compounds 1-3 preferably as a polymerization initiator-origin residue, and as a result, it is possible to obtain a graft yield better than that of a composition having the same monomer composition ratio.

The content of the acid group-containing unsaturated monomer (including the monomer used to form homopolymers of the acid group-containing unsaturated monomer) in the composition is generally below 1000 ppm by weight, preferably below 100 ppm by weight and optimally, it is 0 ppm by weight.

### [Compound 1-3]

In the polymer composition of this invention, at least one of the compound 1-3 shown in the following formulas is contained.

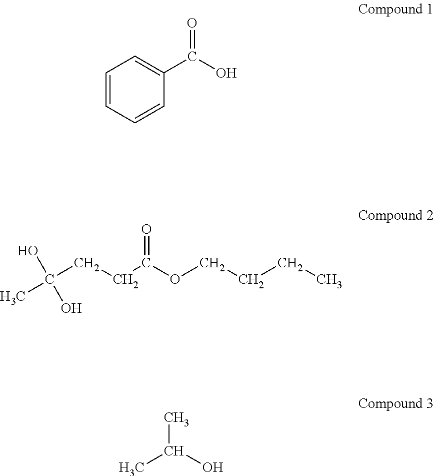

These compounds are, as explained in detail later, preferably decomposition products of the polymerization initiator used at the time of the production of the graft polymer. Therefore, if, for example, t-butyl peroxybenzoate (also called PBZ, below) us used as a polymerization initiator, the polymer composition contain the compound 1. Similarly, in the case of t-butyl peroxyisopropyl carbonate (also called PBI, below) used as a polymerization initiator, the polymer composition contains the compound 3, and the polymer composition contains the compound 2 if the polymerization initiator used is n-butyl 4,4-di(t-butylperoxy)valerate (also called PHV, below).

Incidentally, those polymerization initiators usable in this invention may be used alone or as a mixture of 2 or more kinds. Therefore, the polymer composition of this invention may contain 2 or more of the above compounds 1-3.

The content of the compounds 1-3 in the polymer composition is preferably in the range of 0.01-2.0 wt % on the total amount (solid component content) of the composition. If the content is in this range, the amount of polymerization initiators used is the proper quantity, and it is possible to prepare a composition containing a graft polymer showing an excellent performance. Incidentally, the above content is the total content if the composition contains 2 or more of the compounds 1-3. The content of the compounds 1-3 in the polymer composition is measured with the method described in the application examples shown later.

Furthermore, the proportion of the compounds 1-3 in the polymer composition on 100 parts by weight of the acid group-containing unsaturated monomer is generally in the range of 0.3-20 parts by weight, preferably 1-10 parts by weight and optimally 1-5 parts by weight. If the proportion is in this range, the amount of polymerization initiators used is the proper quantity, and it is possible to prepare a composition containing a graft polymer showing an excellent ability inhibiting precipitation. Incidentally, the amount of the acid group-containing unsaturated monomer in this case is the total amount of the acid group-containing unsaturated monomer used at the time of the production of the graft polymer. Specifically, the amount of the acid group-containing unsaturated monomer of the polymer composition is the total amount of the acid group-containing unsaturated monomer-origin structure in the graft polymer, acid group-containing unsaturated monomer not consumed in the reaction and homopolymer of the acid group-containing unsaturated monomer.

### [Production Process]

The polymer composition of this invention is prepared with, for example, a specific polymerization initiator (organic peroxide polymerization initiator having a half-life at 135° C. in the range of 6-60 min).

In the paragraph [0058] of the patent reference 2, it is disclosed to be able to achieve effective grafting of a monomer component if the graft polymerization of a polyoxyalkylene compound with an acid group-containing unsaturated monomer is carried out under a condition containing practically no solvent. As a result of diligent studies carried out by the inventors of this invention, the monomer component was effectively grafted to the polyoxyalkylene compound under a condition of a reduced amount of the monomer to the polyoxyalkylene compound according to the graft polymer production process disclosed in the patent reference 2, and thus the residual acid group-containing unsaturated monomer was reduced, but the reaction system was still found to contain the polyoxyalkylene compound.

Specifically, according to the process disclosed in the patent reference 2, it is possible to prepare a graft polymer having a large proportion of the acid group-containing unsaturated monomer-origin structure and polyoxyalkylene compound not consumed in the reaction containing no acid group-containing unsaturated monomer-origin structure at all. Therefore, this graft polymer production process is found to be suitable for the production of a graft polymer having the localized acid group-containing unsaturated monomer-origin structure.

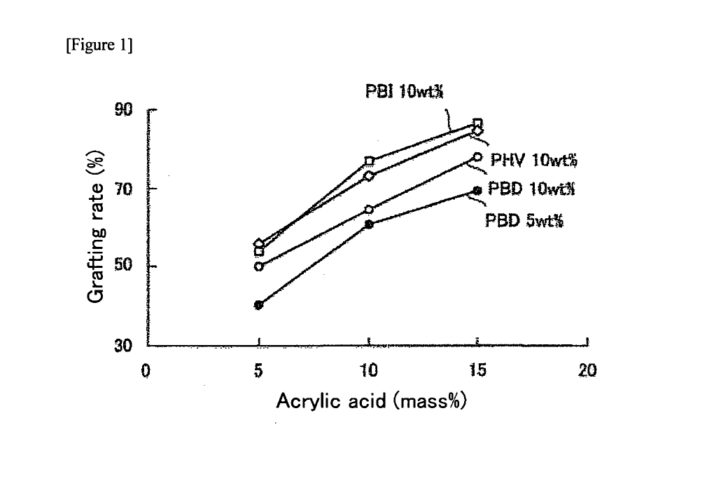

The inventors of this invention studied further and found that if the graft polymer production was carried out with a special polymerization initiator, it was possible to prepare a polymer composition with an improved yield of graft polymer under the condition of the amount of the acid group-containing unsaturated monomer used was extremely low compared with the polyoxyalkylene compound. As shown in FIG. 1, if PBI or PHV was used as a polymerization initiator, the grafted structure yield [mass of the polymer (graft polymer) of the polyoxyalkylene compound and acid group-containing unsaturated monomer/total amount of mass of the polyoxyalkylene compound and acid group-containing unsaturated monomer added to the reaction system] was found to be improved compared with the result in the case of di-tert-butyl peroxide (also called “PBD”, below) used as a polymerization initiator. Namely, the above results obtained imply that if the graft polymer is prepared with a special polymerization initiator, it is possible to allow the acid group-containing unsaturated monomer-origin structure to be present not in a localized state but in a uniformly distributed state.

In addition to the above finding, the inventors of this invention also found that, if the ratio of the specified polyoxyalkylene compound-origin structure to the acid group-containing unsaturated monomer-origin structure was specified, the ability dispersing lime soap could be synergistically improved.

The ability dispersing lime soap shows a decreasing tendency when the proportion of the acid group-containing unsaturated monomer-origin structure to the polyoxyalkylene compound-origin structure is too high or low from a certain level, but as apparent from the results shown in FIG. 1, the polymerization reaction can be carried out homogeneously if a special polymerization initiator is used, and it is possible to produce a polymer having a structure of high performance effectively.

For the purpose of handling convenience, the polymer composition prepared is generally diluted with a small amount of water before storage. The polymer composition of this invention was found to have extremely good stability in the case of dilution with water compared with a graft polymer composition prepared with the previously available process for the production. If the special polymerization initiator of this invention is used, the polymer yield is improved reducing the amount of the residual polyoxyalkylene compound in the polymer composition. Incidentally, the mechanism described above is merely guessing, and it is not necessarily limited to this.

In this invention, the process for the production of the polymer composition is not especially restricted, and the production is possible by suitably referring to the previously known knowledge. Preferably as disclosed in the patent reference 2, the mass polymerization (or bulk polymerization) is used practically, and specifically, the polymerization is carried out with the solvent content below 10 wt % of the total amount of the reaction system as a reaction system of this graft polymerization. The specific form or state of polymerization is not especially restricted, and any of those previously known findings related to mass polymerization (bulk polymerization) may be referred and improved if necessary.

To carry out graft polymerization, it is necessary first to prepare the required amounts of the polyoxyalkylene compound to become the trunk of the graft polymer to be prepared and monomer component becoming the branches of the graft polymer. The amounts of respective components to be prepared in this case are as a ratio by weight of polyoxyalkylene compound: acid group-containing unsaturated monomer=80:20 to 50:50, especially 78:22 to 50:50, furthermore, 77:23 to 55:45, preferably 76:24 to 60:40 and optimally 75:25 to 65:35.

Incidentally, when the weight ratio of polyoxyalkylene compound-origin structure to acid group-containing unsaturated monomer-origin structure is to be calculated, the weight of the structure of the acid group-containing unsaturated monomer is that of the corresponding acid-type derivative.

As a polymerization initiator used in case the graft polymerization is to be carried out, the organic peroxide polymerization initiators (special polymerization initiator of this invention) having a half-life at 135° C. in the range of 6-60 min are suitably usable. The use of these polymerization is desirable because the grafting yield is improved.

In this invention, the half-life at 135° C. is measured with the method described in an organic peroxide brochure, 10^{th} edition of Nichiyu K.K. Specifically, the measurement method with the following procedures is used.

First of all, with a relatively inert solvent (such as benzene, etc.), 0.1 or 0.05 mol/L solutions is prepared for a polymerization initiator, and the solution prepared is sealed in a nitrogen-substituted glass tube. It is soaked in an isothermal bath set at 135° C. to carry out thermal decomposition. The time required for the polymerization initiator concentration becoming one-half of the initial concentration is determined with these procedures.

As an organic peroxide initiator having the half-life at 135° C. in the range of 6-60 min, there are, for example, t-butyl peroxyisopropyl monoarbonate (half-life of 13 min), t-hexylperoxyisopropyl monocarbonage (half-life of 6.3 min), n-butyl 4,4-di(t-butylperoxy)valerate (half-life of 30 min)ₜ-butyl peroxybenzoate (half-life of 22 min), t-hexyl peroxybenzoate (half-life of 15.6 min)2,5-dimethyl-2,5-di(benzoylperoxy)hexane (half-life of 13.1 min).

The amount of this organic peroxide polymerization initiator having a half-life at 135° C. in the range of 6-60 min to be used is not especially restricted, but it is generally in the range of 1-15 mass %, preferably 2-10 mass % and optimally 3-7 mass % with 100 mass % of the acid group-containing unsaturated monomer used in the graft polymerization reaction.

If the amount of organic peroxide polymerization initiator used is too small, there is a risk of the yield of the grafted structure of the polyoxyalkylene compound with the monomer component being reduced. On the other hand, if the amount of organic peroxide polymerization initiator used is too high, the reaction of the polyoxyalkylene compound by itself is liable to be carried out, and as a result of high viscosity generated due to a high molecular weight, the production of the desired graft polymer becomes difficult, furthermore, the high molecular weight generation is also liable to cause gelation of the composition forming an insoluble content deteriorating the product quality. Furthermore, the production costs are liable to be increased.

In addition to the organic peroxide polymerization initiator having a half-life at 135° C. in the range of 6-60 min, other polymerization initiators may be suitably used. However, to obtain the marked effect of this invention reducing the amount of the polyoxyalkylene compound not consumed in the reaction, the amount of other polymerization initiators has to be less than 10 wt % of the total amount of all polymerization initiators used, the amount is preferably below 5 wt %, and optimally, it is 0 wt %. (no other polymerization initiators used). As another polymerization initiator, organic peroxides are preferably used, and any of those previously known organic peroxides is used suitably.

The addition mode of the organic peroxide polymerization initiator having a half-life at 135° C. in the range of 6-60 min and in some cases, other polymerization initiators is not especially restricted. However, the addition is preferably carried out concomitantly with the monomer component in a state not being mixed with the polyoxyalkylene compound in advance. In spite of this, it is still possible to carry out the graft polymerization with the polymerization initiator partially added to at least one of the polyoxyalkylene compound or monomer component.

In the case of graft polymerization, it is also possible to use, in addition to those polymerization initiators described above, catalyst for the decomposition of the polymerization initiator used or reducing substance in the reaction system. As a polymerization initiator-decomposition catalyst, there are, for example, metal halides such as lithium chloride, lithium bromide, etc.; metal oxides such as titanium oxide, silicon dioxide, etc.; metal salts of inorganic acids such as hydrochloric acid, hydrobromic acid, perchloric acid, sulfuric acid, nitric acid, etc.; carboxylic acids such as formic acid, acetic acid, propionic acid, butyric acid, isobutyric acid, benzoic acid, etc., their esters and metal salts; heterocyclic amines such as pyridine, indole, imidazole, carbazole, etc., and their derivatives. These decomposition catalysts may be used alone or concomitantly as a mixture of 2 or more kinds.

Furthermore, as a reducing compound, there are, for example, organometallic compounds such as ferrocene, etc.; inorganic compounds such as iron naphthenate, copper naphthenate, nickel naphthenate, cobalt naphthenate, manganese naphthenate, etc., generating ions of metal elements such as iron, copper, nickel, cobalt, manganese, etc.; inorganic compounds such as trifluoroboron ether adduct, potassium permanganate, perchloric acid, etc.; sulfur compounds such as sulfur dioxide, sulfite, sulfate, hyposulfite, thiosulfate, sulfoxylate, cyclic sulfinic acids such as benzenesulfinate or its substituted derivative, paratoluenesulfinic acid, etc., or analogs, etc.; mercapto compounds such as octyl mercaptan, dodecyl mercaptan, mercaptoethanol, a-mercaptopropionic acid, thioglycolic acid, thiopropionic acid, sodium α-thioproionate sulfopropyl ester, sodium α-thioproionate sulfoethyl ester, etc.; nitrogen-containing compounds such as hydrazine, β-hydroxyethylhydrazine, hydroxylamine, etc.; aldehydes such as formaldehyde, acetaldehyde, propionaldehyde, n-butylaldehyde, isobutylaldehyde, isovaleroaldehyde, etc.; and ascorbic acid. These reducing compounds are usable alone or concomitantly as a mixture of 2 or more kinds. Those reducing compounds such as mercapto compounds, etc., may be added as a chain-transfer agent.

The amount of a solvent to be used is less than 10 wt % on the total amount of the reaction system, especially less than 7 wt %, furthermore, less than 5 wt %, preferably less than 3 wt %, and optimally the reaction system contains practically no solvent. The phrase “contains practically no solvent” means no active addition of any solvent at the time of graft polymerization, and the presence of a very small amount a solvent at the level of impurities is allowed.

If the reaction system contains a solvent, the solvent to be used is not especially restricted, but it is preferable to use a solvent showing a small chain-transfer constant from the monomer content to the solvent, having a boiling point above about 70° C., and thus, being usable under atmospheric pressure. As a specific example of such a solvent, there are, for example, alcohols such as isobutyl alcohol, n-butyl alcohol, tert-butyl alcohol, isopropyl alcohol, ethylene glycol, diethylene glycol, glycerol, triethylene glycol, propylene glycol, ethylene glycol monoalkyl ether, propylene glycol monoalkyl ether, etc.; diethers such as ethylene glycol dialkyl ether, propylene glycol dialkyl ether, etc.; acetate type compounds such as acetic acid, ethyl acetate, propyl acetate butyl acetate, ethylene glycol monoalkyl ether acetate, propylene glycol monoalkyl ether acetate, etc. These solvents may be used alone or concomitantly as a mixture of 2 or more kinds. As an alkyl group usable in the alcohols and diethers described above, there are, for example, methyl, ethyl, propyl, butyl, etc.

The temperature of the graft polymerization is above 100° C., generally in the range of 100-160° C., preferably 110-150° C. and optimally 130-140° C. If the temperature at the time of polymerization is too low, the viscosity of the reaction mixture is liable to become too high to carry out the graft polymerization reaction smoothly, and the grafting rate of the monomer component is liable to be reduced. On the other hand, if the temperature at the time of polymerization is too high, there is a risk of the polyoxyalkylene compound and graft polymer formed are liable to be thermally decomposed, and the monomer and initiator may be lost as a result of evaporation. Incidentally, the temperature at the time of graft polymerization is not necessarily maintained always constant while the polymerization reaction is carried out. For example, the polymerization reaction may be started at room temperature, the temperature is subsequently raised to a desired level with a suitable temperature-increasing time or speed, and subsequently, the temperature set may be held. Alternatively, the polymerization temperature may be allowed to fluctuate with time (temperature elevation or reduction) depending on the method adding the monomer components, polymerization initiator, etc., in drops.

The polymerization time is not especially restricted, but it is generally in the range of 30-420 min, especially 45-390 min, preferably 60-360 min and optimally 90-240 min. Incidentally, the “polymerization time” in this invention means time when the monomers are added.

The pressure inside the reaction system may be any of atmospheric (normal) pressure, reduced pressure or added pressure, but considering the molecular weight of the polymer to be prepared, the reaction is preferably carried out under atmospheric pressure or added pressure by sealing the reaction system. Furthermore, if the equipment and facility required such as pressurizing or vacuum devices, pressure-resistant reactor, piping system, etc., are considered, there is an advantage of carrying out the reaction under atmospheric pressure, and thus, it is preferable. The atmosphere inside he reaction system may be air, but the use of an insert gas is preferable, and the reaction system inside the reactor is preferably substituted with an inert gas such as nitrogen, etc., prior to staring the polymerization reaction.

At the time of graft polymerization, the reaction system is charged with a portion or all of the polyoxyalkylene compound becoming the stem of he graft polymer to start the polymerization. The reaction system is charged, for example, with the whole mount of the polyoxyalkylene compound, the temperature is raised, the monomer component and polymerization initiator are added separately to continue the graft polymerization. In this manner, the molecular weight of the polymer to be prepared is easily adjustable, and thus, it is preferable. Incidentally, the graft polymerization may be carried out in a batch or continuous system.

The polymer composition of this invention is usable as a water-treatment agent, fiber-treatment agent, dispersant, detergent builder (or detergent composition), etc. As a detergent builder, it is applicable to detergents of various application fields such as clothing, dish-washing, home, hair shampoo, body washing, tooth brushing, car washing, etc.

### <Laundry Detergent and Cleaning Compositions Use of the Copolymer>

The polymer composition of this invention is usable in detergent compositions.

The polymer composition of this invention contains the graft polymer described above, and the content of the graft polymer in detergent compositions is not especially restricted. However, from the viewpoint of allowing the copolymer to exhibit its excellent builder performance, the content of the hydrophobic group-containing copolymer is in the range of 0.1-20 wt %, preferably 0.3-15 wt % and optimally 0.5-10 wt % on the total amount of detergent composition.

The copolymers of the present invention may be utilized in laundry detergents or cleaning compositions comprising a surfactant system comprising C₁₀-C₁₅ alkyl benzene sulfonates (LAS) and one or more co-surfactants selected from nonionic, cationic, anionic or mixtures thereof. The selection of co-surfactant may be dependent upon the desired benefit. In one embodiment, the co-surfactant is selected as a nonionic surfactant, preferably C₁₂-C₁₈ alkyl ethoxylates. In another embodiment, the co-surfactant is selected as an anionic surfactant, preferably C₁₀-C₁₈ alkyl alkoxy sulfates (AE_{X}S) wherein x is from 1-30. In another embodiment the co-surfactant is selected as a cationic surfactant, preferably dimethyl hydroxyethyl lauryl ammonium chloride. If the surfactant system comprises C₁₀-C₁₅ alkyl benzene sulfonates (LAS), the LAS is used at levels ranging from about 9% to about 25%, or from about 13% to about 25%, or from about 15% to about 23% by weight of the composition.

The above-mentioned laundry detergent or cleaning composition preferably comprises from about 1% to about 20% by weight of the hydrophobic group-containing copolymer composition.

The surfactant system may comprise from 0% to about 7%, or from about 0.1% to about 5%, or from about 1% to about 4% by weight of the composition of a co-surfactant selected from a nonionic co-surfactant, cationic co-surfactant, anionic co-surfactant and any mixture thereof.

Non-limiting examples of nonionic co-surfactants include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Non-limiting examples of semi-polar nonionic co-surfactants include: water-soluble amine oxides containing one alkyl moiety of from about 10 to about 18 carbon atoms and 2 moieties selected from the group consisting of alkyl moieties and hydroxyalkyl moieties containing from about 1 to about 3 carbon atoms; water-soluble phosphine oxides containing one alkyl moiety of from about 10 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. No. 4,681,704, and U.S. Pat. No. 4,133,779.

Non-limiting examples of cationic co-surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Nonlimiting examples of anionic co-surfactants useful herein include: C₁₀-C₂₀ primary, branched chain and random alkyl sulfates (AS); C₁₀-C₁₈ secondary (2,3) alkyl sulfates; C₁₀-C₁₈ alkyl alkoxy sulfates (AEₓS) wherein x is from 1-30; C₁₀-C₁₈ alkyl alkoxy carboxylates comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

The present invention may also relates to compositions comprising the inventive copolymers and a surfactant system comprising C₈-C₁₈ linear alkyl sulphonate surfactant and a co-surfactant. The compositions can be in any form, namely, in the form of a liquid; a solid such as a powder, granules, agglomerate, paste, tablet, pouches, bar, gel; an emulsion; types delivered in dual-compartment containers; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a consumer; and other homogeneous or multiphase consumer cleaning product forms.

In one embodiment, the cleaning composition of the present invention is a liquid or solid laundry detergent composition. In another embodiment, the cleaning composition of the present invention is a hard surface cleaning composition, preferably wherein the hard surface cleaning composition impregnates a nonwoven substrate. As used herein “impregnate” means that the hard surface cleaning composition is placed in contact with a nonwoven substrate such that at least a portion of the nonwoven substrate is penetrated by the hard surface cleaning composition, preferably the hard surface cleaning composition saturates the nonwoven substrate. The cleaning composition may also be utilized in car care compositions, for cleaning various surfaces such as hard wood, tile, ceramic, plastic, leather, metal, glass. This cleaning composition could be also designed to be used in a personal care and pet care compositions such as shampoo composition, body wash, liquid or solid soap and other cleaning composition in which surfactant comes into contact with free hardness and in all compositions that require hardness tolerant surfactant system, such as oil drilling compositions.

In another embodiment the cleaning composition is a dish cleaning composition, such as liquid hand dishwashing compositions, solid automatic dishwashing compositions, liquid automatic dishwashing compositions, and tab/unit does forms of automatic dishwashing compositions.

Automatic detergent compositions may comprise low foaming nonionic surfactants (LFNIs). LFNI can be present in amounts from about 0.25% to about 4%. LFNIs are most typically used in automatic detergents on account of the improved water-sheeting action (especially from glass) which they confer to the gel automatic detergents. Preferred LFNIs include nonionic alkoxylated surfactants, especially ethoxylates derived from primary alcohols, and blends thereof with more sophisticated surfactants, such as the polyoxypropylene/polyoxyethylene/polyoxypropylene reverse block polymers. The PO/EO/PO polymer-type surfactants are well-known to have foam suppressing or defoaming action, especially in relation to common food soil ingredients such as egg. In a preferred embodiment, the LFNI is an ethoxylated surfactant derived from the reaction of a monohydroxy alcohol or alkylphenol containing from about 8 to about 20 carbon atoms, excluding cyclic carbon atoms, with from about 6 to about 15 moles of ethylene oxide per mole of alcohol or alkyl phenol on an average basis. A particularly preferred LFNI is derived from a straight chain fatty alcohol containing from about 16 to about 20 carbon atoms (C₁₆-C₂₀alcohol), preferably a C₁₈alcohol, condensed with an average of from about 6 to about 15 moles, preferably from about 7 to about 12 moles, and most preferably from about 7 to about 9 moles of ethylene oxide per mole of alcohol. Preferably the ethoxylated nonionic surfactant so derived has a narrow ethoxylate distribution relative to the average.

The LFNI can optionally contain propylene oxide in an amount up to about 15% by weight. Certain of the block polymer surfactant compounds designated PLURONIC® and TETRONIC® by the BASF-Wyandotte Corp., Wyandotte, Mich., are suitable in gel automatic detergents of the invention. LFNIs which may also be used include a C-18 alcohol polyethoxylate, having a degree of ethoxylation of about 8, commercially available as “SLF-18 Poly-tergent” from BASF Corp.

Dish washing compositions may additionally contain a dispersant polymer typically in the range from 0 to about 25%, preferably from about 0.5% to about 20%, more preferably from about 1% to about 7% by weight of the detergent. The dispersant polymer may be ethoxylated cationic diamines or ethoxylated cationic polyamines described in U.S. Pat. No. 4,659,802. Other dispersant polymers suitable for use include co-polymers synthesized from acrylic acid, maleic acid and methacrylic acid such as ACUSOL® 480N supplied by Rohm & Haas and an acrylic-maleic (ratio 80/20) phosphono end group dispersant copolymers sold under the tradename of Acusol 425N (E) available from Rohm &Haas. Polymers containing both carboxylate and sulphonate monomers, such as ALCOSPERSE® polymers (supplied by Alco) are also acceptable dispersant polymers. In one embodiment an ALCOSPERSE® polymer sold under the trade name ALCOSPERSE® 725, is a co-polymer of Styrene and Acrylic Acid with the following structure:

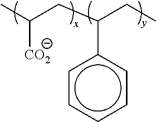

x:y=60:40, or 50:50, MW=8000.
   ALCOSPERSE® 725 may also provide a metal corrosion inhibition benefit.

Other dispersant polymers are low molecular weight modified polyacrylate copolymers including the low molecular weight copolymers of unsaturated aliphatic carboxylic acids disclosed in U.S. Pat. Nos. 4,530,766, and 5,084,535 and European Patent Application No. 66,915, published Dec. 15, 1982.

Dish washing compositions may utilize detergent builders to assist in controlling mineral hardness and dispersancy. Inorganic as well as organic builders can be used. Embodiment of such dish washing product can be selected from the group consisting of phosphate, phosphate oligomers or polymers and salts thereof, silicate oligomers or polymers and salts thereof, aluminosilicates, magnesioaluminosiliates, citrate, methyl glycine diacetic acid and/or salts thereof, glutamatic diacetic acid and/or salts thereof and mixtures thereof. Phosphate detergent builders include, but are not limited to, the alkali metal, ammonium and alkanolammonium salts of polyphosphates. Silicate builders herein are any silicates which are soluble to the extent that they do not adversely affect spotting/filming characteristics of the gel detergent composition. Aluminosilicate builders can be used in the present compositions though are not preferred for automatic dishwashing detergents. Carbonate builders include alkaline earth and alkali metal carbonates as disclosed in German Patent Application No. 2,321,001 published on Nov. 15, 1973. Various grades and types of sodium carbonate and sodium sesquicarbonate can be used, certain of which are particularly useful as carriers for other ingredients, especially: detersive surfactants. Organic detergent builders include a wide variety of polycarboxylate compounds. Other useful builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various I alkali metal, ammonium and substituted ammonium salts of polyacetic acids such as ethylenediaminetetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof. Citrate builders, e.g., citric acid and soluble salts thereof (particularly sodium salt), are polycarboxylate builders of particular importance for heavy duty laundry detergent and automatic dishwashing formulations due to their availability from renewable resources and their biodegradability. Methyl glycine diacetic acid and/or salts thereof (MGDA) may also be utilized as builders in the present composition. A preferred MGDA compound is a salt of methyl glycine iacetic acid Suitable salts include the diammonium 1.0 slt, the dipotassium salt and, preferably, the disodium salt. Glutamatic diacetic acid and/or salts thereof (GLDA) may also be utilized as builders in the present compositions. A preferred GLDA compound is a salt of glutamic diacetic acid. Suitable salts include the diammonium salt, the dipotassium salt and, preferably, the disodium salt. 1-hydroxyethylidene-1,1-diphosphonic acid (HEDP) may also be utilized as a builder in the present compositions.

Perfume may be added to the compositions of the present invention. The detergent compositions can contain agents that are effective as corrosion inhibitors and/or anti-tarnish aids.

“Detergent enzyme”, as used herein, means any enzyme having a cleaning, stain removing or otherwise beneficial effect in a gel detergent composition. Preferred enzymes are hydrolases such as proteases, amylases and lipases. Highly preferred for automatic dishwashing are amylases and/or proteases, including both current commercially available types and improved types. Enzyme-containing compositions herein can comprise from about 0.001% to about 10%, preferably from about 0.005% to about 8%, most preferably from about 0.01% to about 6%, by weight of an enzyme.

The compositions herein can also optionally contain one or more transition-metal selective sequestrants, “chelants” or “chelating agents”, e.g., iron and/or copper and/or manganese chelating agents. Chelating agents suitable for use herein can be selected from the group consisting of aminocarboxylates, phosphonates (especially the aminophosphonates), polyfunctionally-substituted aromatic chelating agents, and mixtures thereof. Commercial chelating agents for use herein include the BEQUEST series, and chelants from Monsanto, DuPont, and Nalco, Inc.

The detergent composition can be preferably low foaming, readily soluble in the washing medium and most effective at pH values best conducive to improved cleaning performance, such as in a range of desirably from about pH 6.5 to about pH 12.5, and preferably from about pH 7.0 to about pH 12.0, more preferably from about pH 8.0 to about pH 12.0. The pH adjusting components are desirably selected from sodium or potassium hydroxide, sodium or potassium carbonate or sesquicarbonate, sodium or potassium silicate, boric acid, sodium or potassium bicarbonate, sodium or potassium borate, and mixtures thereof.

An embodiment of the present invention relates to a gel detergent composition comprising an organic solvent selected from the group consisting of low molecular weight aliphatic or aromatic alcohols, low molecular weight alkylene glycols, low molecular weight alkylene glycol ethers, low molecular weight esters, low molecular weight alkylene amines, low molecular weight alkanolamines, and mixtures thereof.

Any adjunct ingredient in any amount may be used in the gel detergent composition. For example, adjunct ingredients may be selected from the group consisting of nanoparticles, functionalized surface molecules, polymers, surfactants, co-surfactants, metal ions, proteins, dyes, acids, optical brighteners, colorants, filler salts, hydrotropes, preservatives, anti-oxidants, germicides, fungicides, color speckles, solubilizing agents, carriers and mixtures thereof.

Quite typically, cleaning compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials can be found in WO 99/05242.

Common cleaning adjuncts include builders, enzymes, polymers not discussed above, bleaches, bleach activators, catalytic materials and the like excluding any materials already defined hereinabove. Other cleaning adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents, surface and skin care agents. Suitable examples of such other cleaning adjuncts and levels of use are found in U.S. Pat. Nos. 5,576,282, 6,306,812 B1 and 6,326,348 B1.

The above-mentioned laundry detergent or cleaning composition preferably contains cleaning adjunct additives selected from the group consisting of enzymes, alkali builders, chelant builders, bleaches, bleaching assisting agents, perfumes, defoaming agents, bactericides, corrosion inhibitors, and mixtures thereof.

### Method of Use

The present invention includes a method for cleaning a targeted surface. As used herein “targeted surface” may include such surfaces such as fabric, dishes, glasses, and other cooking surfaces, hard surfaces, hair or skin. As used herein “hard surface” includes hard surfaces being found in a typical home such as hard wood, tile, ceramic, plastic, leather, metal, glass. Such method includes the steps of contacting the composition comprising the modified polyol compound, in neat form or diluted in wash liquor, with at least a portion of a targeted surface then optionally rinsing the targeted surface. Preferably the targeted surface is subjected to a washing step prior to the aforementioned optional rinsing step. For purposes of the present invention, washing includes, but is not limited to, scrubbing, wiping and mechanical agitation.

As will be appreciated by one skilled in the art, the cleaning compositions of the present invention are ideally suited for use in home care (hard surface cleaning compositions) and/or laundry applications.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

For use in laundry cleaning compositions, the compositions are preferably employed at concentrations from about 200 ppm to about 10000 ppm in solution (or wash liquor). The water temperatures preferably range from about 5° C. to about 60° C. The water to fabric ratio is preferably from about 1:1 to about 20:1.

The method may include the step of contacting a nonwoven substrate impregnated with an embodiment of the composition of the present invention. As used herein “nonwoven substrate” can comprise any conventionally fashioned nonwoven sheet or web having suitable basis weight, caliper (thickness), absorbency and strength characteristics. Examples of suitable commercially available nonwoven substrates include those marketed under the tradename SONTARA® by DuPont and POLYWEB® by James River Corp.

As will be appreciated by one skilled in the art, the cleaning compositions of the present invention are ideally suited for use in liquid dish cleaning compositions. The method for using a liquid dish composition of the present invention comprises the steps of contacting soiled dishes with an effective amount, typically from about 0.5 ml. to about 20 ml. (per 25 dishes being treated) of the liquid dish cleaning composition of the present invention diluted in water.

The change (difference) in the kaolin turbidity with and without the polymer composition of this invention added as a detergent builder to a liquid detergent composition is generally below 500 mg/L, especially 400 mg/L, furthermore 300 mg/L, preferably 200 mg/L and optimally 100 mg/L. The kaolin turbidity is the value measured with the following method.

### <Kaolin Turbidity Measurement Method>

A 10 mm thick and 50 mm square ell is filled with a sample (liquid detergent) stirred thoroughly to form a homogeneous state, and after degassing, the turbidity (kaolin turbidity: mg/L) is measured at 25° C. with a Nippon Denshoku turbidity meter, Model NDH2000 (trade name: rabidity meter).

The detergent composition of this invention shows an excellent washing effect with little salt precipitation even it is used in a region known to have hard water having relatively high concentrations (e.g., 100 mg/L or higher) of calcium and magnesium ions. This effect is especially apparent if the detergent composition contains an anionic surfactant such as LAS.

The present invention further contains a cleaning implement comprising a nonwoven substrate and the above-mentioned laundry detergent or cleaning composition.

### APPLICATION EXAMPLES

This invention is explained further in detail with application examples as follows, but this invention is not necessarily limited to these application examples alone. Incidentally, the “part” used is “part by weight” and “%” is “% by weight” unless specified.

Furthermore, the weight-average molecular weight, numerical average molecular weight of the graft polymer of this invention, precipitation inhibitory ability, quantitative determination of polyoxyalkylene compound not consumed, quantitative determination of the compounds 1-3, solid contents of polymer composition and polymer aqueous solution were measured according the methods as follows.

### <Weight-Average and Numerical Average Molecular Weight Measurement Conditions (GPC)>

Instrument: Hitachi L-7000 series

### Detector: RI

### Column: Showa Denko SHODEX Asahipak GF-310-HQ, GF-7, 10-HQ, GF-1G 7B

Column temperature: 40° C.
Flow rate: 0.5 mL/min
Working curve: Sowa Kagaku polyethylene glycol standard
Elution solution: 0.1 N sodium acetate/acetonitrile=3/1 (ratio by weight)

### <Quantitative Determination of Polyoxyalkylene Compound not Consumed>

The quantitative determination of the polyoxyalkylene compound not consumed in the reaction in the polymer composition was carried out with high performance liquid chromatography carried out under the following conditions.

### High-Performance Liquid Chromatography

Measurement instrument: Toso K.K 8020 Series

### Column: Shiseido Capcell Pak C1 UG120

### Temperature: 40.0° C.

Elution solution: 10 mmol/L aqueous solution of disodium hydrogen phosphate dodecahydrate (adjusted to pH 7 with phosphoric acid)/acetonitrile=45/55 (volume ratio)
Flow rate: 1.0 mL/min
Detector: RI, UV (wavelength of 215 nm)

### <Quantitative Determination Method for the Compounds 1-3>

The quantitative determination of the compounds 1-3 in the polymer composition was carried out with high-performance liquid chromatography under the following conditions.

### High-Performance Liquid Chromatography

Measurement instrument: Toso K.K 8020 Series

### Column: Shiseido Capcell Pak C1 UG120

### Temperature: 40.0° C.

Elution solution:
(For compounds 1 and 3)
10 mmol/L aqueous solution of disodium hydrogen phosphate dodecahydrate (adjusted to pH 7 with phosphoric acid)/acetonitrile=90/10 (volume ratio) (For compound 2)
10 mmol/L aqueous solution of disodium hydrogen phosphate dodecahydrate (adjusted to pH 7 with phosphoric acid)/acetonitrile=30/70 (volume ratio)
Flow rate: 1.0 mL/min
Detector: RI, UV (wavelength of 215 nm)

### <Method for Measurement of Solid Content of Polymer Composition>

In an over at 130° C. under a nitrogen atmosphere, the polymer composition (1.0 g of polymer composition+3.0 g of water) was allowed to stand for 1 h to carry out a drying treatment. From the weight difference before and after drying, the solid content (%) and volatile component (%) were calculated.

### <Measurement of the Amount of Acid Group-Containing Unsaturated Monomer (Acrylic Acid) in Polymer Composition>

The acrylic acid content measurement was carried out with liquid chromatography under the condition in Table 1 as follows.

Instrument: Hitachi L-7000 series
Detector: Hitachi UV detector, Model L-7400

### Column: Showa Denko SHODEX RSpak DE-413

Column temperature: 40.0° C.
Elution solution: 0.1% aqueous solution of phosphoric acid
Flow rate: 1.0 mL/min

### <Grafted Form Yield Measurement>

Graft polymer content (mass %) in polymer composition (solid content)=grafted form yield

Specifically, it is a proportion of the mass of the graft polymer contained in the polymer composition on the mass of the solid content of the polymer composition, and it is calculated from the following formula.

Graft polymer content (mass %) in polymer composition (solid content)=100(%)−[Content (%) of polyoxyalkylene compound not consumed in polymer composition+content (%) of acid group-containing unsaturated monomer in the solid content of polymer composition+content (%) of the compounds 1-3 in the solid content of polymer composition+homopolymer of acid group-containing unsaturated monomer alone]

Incidentally, the quantitative determination of the homopolymer of acid group-containing unsaturated monomer alone was carried out with capillary electrophoresis measurement under the following conditions.

### <Electrophoresis Measurement Conditions>

### Instrument: Photal Otuka Electronics CAPI-3300 Capillary Electrophoresis System

Column: Otuka Electronics GL capillary tube 75μ×50 cm

### Voltage: 15 kV

Development solvent: 50 mmol/L aqueous solution of sodium 4-borate
Electrophoresis time: 30 min

### Detection: UV 210 nm

### <Measurement Method for Lime Soap Dispersion (Also Called Ability to Disperse Lime Soap)>

(1) To 1.5 g of a 1% aqueous solution of polymer and 7.5 g of a 1% aqueous solution of sodium oleate, pure water was added to make up to 79.5 g.

(2) Subsequently, 0.5 mL of a 6% aqueous solution of calcium chloride/magnesium chloride (Ca:Mg=3:2 mol ratio) (calcium carbonate conversion), and the mixture was stirred for 30 sec.

(3) The transmittance of the aqueous solution was measured with a luminous electrode. For the measurement, a Hiranuma Sangyo automated titrator (main unit: COM-550, light measurement unit: M-500) was used.

### Application Example 1

A 500 mL glass separable flask quipped with a stirrer (paddle blades) was charged with 204.6 g of New Cole 2320 (20 mol ethylene oxide adduct of C₁₂₋₁₃ alcohol manufactured by Nippon Nyukazai K.K.), nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 87.7 g of 100% acrylic acid (also called “AA”, below) and 4204 μL (4.39 g, 5.0 wt % of AA) of t-butyl peroxybenzoate (also called “PBZ”, below) as a polymerization initiator were added in drops respectively from different nozzles. The dropping time was 210 min for PBZ, and the addition of AA was carried out for 210 min from 20 min after the start of PBZ addition. The addition was carried out continuously at a constant speed for both solutions.

After completing AA addition in drops, the reaction mixture solution was maintained (aged) at 135° C. for 70 min to complete the polymerization reaction. After completing the reaction, the reaction mixture was cooled while stirring, and 74.0 g of pure water was added to dilute the solution.

As a result, an aqueous solution with a weight-average molecular weight of 4600 and solid content concentration (mass) of 80.3% was prepared (polymer composition 1).

### Application Example 2

A 500 mL glass separable flask quipped with a stirrer (paddle blades) was charged with 204.6 g of New Cole 2360 (60 mol ethylene oxide adduct of C₁₂₋₁₃ alcohol manufactured by Nippon Nyukazai K.K.), nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 87.7 g of 100% AA and 4204 μL (4.39 g, 5.0 wt % of AA) of PBZ as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions. After completing AA addition in drops, the reaction mixture solution was maintained (aged) at 135° C. for 70 min to complete the polymerization reaction. After completing the reaction, the reaction mixture was cooled while stirring, and 74.0 g of pure water was added to dilute the solution.

As a result, an aqueous solution with a weight-average molecular weight of 12000 and solid content concentration (mass) of 80.5% was prepared (polymer composition 2).

### Application Example 3

A 500 mL glass separable flask quipped with a stirrer (paddle blades) was charged with 204.6 g of New Cole 2310 (10 mol ethylene oxide adduct of C₁₂₋₁₃ alcohol manufactured by Nippon Nyukazai K.K.), nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 87.7 g of 100% AA and 4204 μL (4.39 g, 5.0 wt % of AA) of PBZ as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions. After completing AA addition in drops, the reaction mixture solution was maintained (aged) at 135° C. for 70 min to complete the polymerization reaction. After completing the reaction, the reaction mixture was cooled while stirring, and 74.0 g of pure water was added to dilute the solution.

As a result, an aqueous solution with a weight-average molecular weight of 5300 and solid content concentration (mass) of 80.3% was prepared (polymer composition 3).

### Application Example 4

A 500 mL glass separable flask quipped with a stirrer (paddle blades) was charged with 65.7 g of New Cole 2310, nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 43.8 g of 100% AA and 2100 μL (2.19 g, 5.0 wt % of AA) of PBZ as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions. After completing AA addition in drops, the reaction mixture solution was maintained (aged) at 135° C. for 70 min to complete the polymerization reaction. After completing the reaction, the reaction mixture was cooled while stirring, and 28.0 g of pure water was added to dilute the solution.

As a result, an aqueous solution with a weight-average molecular weight of 15000 and solid content concentration (mass) of 80.2% was prepared (polymer composition 4).

### Application Example 5

A 500 mL glass separable flask quipped with a stirrer (paddle blades) was charged with 76.5 g of New Cole 1020 (20 mol ethylene oxide adduct of 2-ethylhexylalohol manufactured by Nippon Nyukazai K.K.), nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 32.8 g of 100% AA and 1572 μL (1.64 g, 5.0 wt % of AA) of PBZ as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions. After completing AA addition in drops, the reaction mixture solution was maintained (aged) at 135° C. for 70 min to complete the polymerization reaction. After completing the reaction, the reaction mixture was cooled while stirring, and 27.8 g of pure water was added to dilute the solution.

As a result, an aqueous solution with a weight-average molecular weight of 5200 and solid content concentration (mass) of 80.4% was prepared (polymer composition 5).

### Application Example 6

A 500 mL glass separable flask quipped with a stirrer (paddle blades) was charged with 76.5 g of New Cole 1020 and 5.5 g of maleic acid (also called “MA”, below), nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 27.3 g of 100% AA and 1572 μL (1.64 g, 5.0 wt % of the total of AA and MA) of PBZ as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions.

After completing AA addition in drops, the reaction mixture solution was maintained (aged) at 135° C. for 70 min to complete the polymerization reaction. After completing the reaction, the reaction mixture was cooled while stirring, and 27.8 g of pure water was added to dilute the solution.

As a result, an aqueous solution with a weight-average molecular weight of 6800 and solid content concentration (mass) of 80.6% was prepared (polymer composition 6).

### Comparative Example 1

A 500 mL glass separable flask quipped with a stirrer (paddle blades) was charged with 204.6 g of New Cole 2320, nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 87.7 g of 100% AA and 4204 μL (4.39 g, 5.0 wt % of AA) of di-t-butyl peroxide (also called “PBD”, below) as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions.

After completing AA addition in drops, the reaction mixture solution was maintained (aged) at 135° C. for 70 min to complete the polymerization reaction. After completing the reaction, the reaction mixture was cooled while stirring, and 74.0 g of pure water was added to dilute the solution.

As a result, an aqueous solution with a weight-average molecular weight of 15000 and solid content concentration (mass) of 80.3% was prepared (comparative polymer composition 1).

### Reference Example 1

A 500 mL glass separable flask quipped with a stirrer (paddle blades) was charged with 204.6 g of 20 mole ethylene oxide adduct o methyl alcohol (also called “PGM25”, below), nitrogen gas was blown in, the temperature was raised to 120° C. while stirring, and the same state was maintained for 1 h to carry out dehydration of the reaction system. Subsequently, a reflux condenser was attached, the temperature was raised to 135° C., and 87.7 g of 100% AA and 4204 μL (4.3 g, 5.0 wt % of AA) of PBZ as a polymerization initiator were added in drops respectively from separate nozzles. The dropping time was 210 min for PBZ, and the addition of AA was carried out for 210 min from 20 min after the start of PBZ addition. The addition was carried out continuously at a constant speed for both solutions.

After completing AA addition in drops, the reaction mixture solution was maintained (aged) at 135° C. for 70 min to complete the polymerization reaction. After completing the reaction, the reaction mixture was cooled while stirring, and 74.0 g of pure water was added to dilute the solution.

As a result, an aqueous solution with a weight-average molecular weight of 4900 and solid content concentration (mass) of 80.1% was prepared (reference polymer composition 2).

### Application Example 7

The grafted form yield and lime soap dispersibility were evaluated for the polymer compositions 1-6, comparative polymer composition 1 and reference polymer composition 1. The results obtained are summarized in the following table.

TABLE 1

| | No. of | Content (mol) of oxy- | Weight ratio of polyoxy- | | |
|---|---|---|---|---|---|
| | carbon | alkylene group-origin | alkylene compound-origin | | |
| | atom in the | structure per mol of | structure to acid group- | | Solid |
| | hydrophobic | polyoxyalkylene | containing unsaturated | Polymerization | content |
| | group | compound | monomer-origin structure | initiator | (%) |
| Application Example 1 | 12 | 20 | 70:30 | PBZ | 80.3 |
| Application Example 2 | 12 | 60 | 70:30 | PBZ | 80.5 |
| Application Example 3 | 12 | 10 | 70:30 | PBZ | 80.3 |
| Application Example 4 | 12 | 10 | 60:40 | PBZ | 80.2 |
| Application Example 5 | 8 | 20 | 70:30 | PBZ | 80.4 |
| Application Example 6 | 8 | 20 | 70:30 | PBZ | 80.6 |
| Comparative Example 1 | 12 | 20 | 70:30 | PBD | 80.3 |
| Reference Example 1 | 1 | 25 | 70:30 | PBZ | 80.1 |

| | | | Specific compound | Specific compound | |
|---|---|---|---|---|---|
| | | Graft | to polymer | to acid group- | |
| | Molecular | polymer | composition | containing | |
| | weight | yield | (solid content) | unsaturated monomer | Lime soap |
| | (Mw/Mn) | (%) | (//illegible//) | (//illelgible//) | dispersibility |
| Application Example 1 | 4600/2000 | 100 | 0.12 | 2.3 | 71 |
| Application Example 2 | 12000/3500 | 100 | 0.16 | 2.4 | 89 |
| Application Example 3 | 5300/1900 | 93 | 0.13 | 2.3 | 92 |
| Application Example 4 | 15000/2900 | 100 | 0.15 | 2.7 | 72 |
| Application Example 5 | 5200/2300 | 87 | 0.15 | 2.3 | 62 |
| Application Example 6 | 6800/2000 | 85 | 0.13 | 2.5 | 65 |
| Comparative Example 1 | 15000/7200 | 65 | 0 | 0 | 46 |
| Reference Example 1 | 4900/2500 | 90 | 0.13 | 2.3 | 10 |

As apparent from the results shown in Table 1, the polymer composition of this invention was shown to have an ability dispersing lime soap better than that of the previous polymer composition.

Therefore, if the polymer composition of this invention is used as a detergent builder, it is expected to prevent any lime soap from being deposited on clothes being washed effectively preventing yellowing, etc., of the fibers even if the washing is carried out with previously used water such as used Japanese bath tub water, etc.

1. A laundry detergent or cleaning composition, which comprises a polymer composition obtainable by carrying out polymerization reaction of a polyoxyalkylene compound and an acid group-containing unsaturated monomer in the presence of a polymerization initiator,
the polyoxyalkylene compound having at least one of aryl group with 8 or more carbon atoms, alkyl group having 8 or more carbon atoms and alkenyl group of 8 or more carbon atoms and oxyalkylene group,
a content of an oxyalkylene-origin structure per mol of the polyoxyalkylene compound being in the range of 10-100 mol; a ratio by weight of a polyoxyalkylene compound-origin structure to the acid group-containing unsaturated monomer-origin structure being in the range of 80:20 to 50:50 (provided 80:20 not included),
and the composition containing 0.3-20 parts by weight of at least one compound selected from the following compounds 1-3 per 100 parts by weight of the acid group-containing unsaturated monomer.

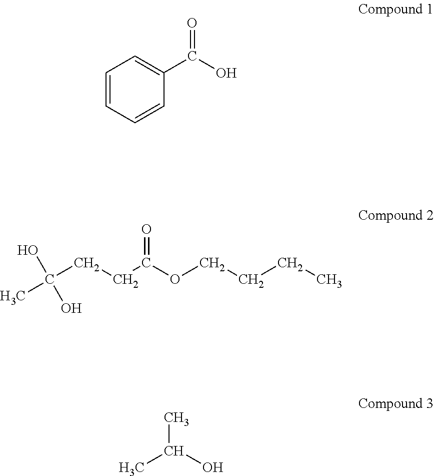

2. A laundry detergent or cleaning composition according to claim 1 wherein the laundry detergent or cleaning composition is selected from the group consisting of liquid laundry detergent compositions, solid laundry detergent compositions, hard surface cleaning compositions, liquid hand dishwashing compositions, solid automatic dishwashing compositions, liquid automatic dishwashing compositions, and tab/unit dose form automatic dishwashing compositions.

3. A laundry detergent or cleaning composition according to claim 1 wherein the detergent or cleaning composition comprises from about 1% to about 20% by weight of the hydrophobic group-containing copolymer composition.

4. A laundry detergent or cleaning composition according to claim 1 wherein the detergent or composition further comprises a surfactant system.

5. A laundry detergent or cleaning composition according to claim 4 wherein the surfactant system comprises C₁₀-C₁₅ alkyl benzene sulfonate.

6. A laundry detergent or cleaning composition according to claim 4 wherein the surfactant system comprises C₈-C₁₈ linear alkyl sulfonate surfactant.

7. A laundry detergent or cleaning composition according claim 4 wherein the surfactant system further comprises one or more co-surfactants selected from the group consisting of nonionic surfactants, cationic surfactants, anionic surfactants, and mixtures thereof.

8. A laundry detergent or cleaning composition according to claim 1 wherein the detergent or composition further comprises cleaning adjunct additives selected from the group consisting of enzymes, alkali builders, chelant builders, bleaches, bleaching assisting agents, perfumes, defoaming agents, bactericides, corrosion inhibitors, and mixtures thereof.

9. A cleaning implement comprising a nonwoven substrate and the laundry detergent or cleaning composition according to claim 1.
